(19) United States
(12) Patent Application Publication
(10) Pub. No.: US 2012/0195034 A1
(43) Pub. Date: Aug. 2, 2012

(54) LIGHT GUIDE ASSEMBLY AND LIGHT FIXTURE USING THE SAME

(76) Inventor: Hung-Pin KUO, Taichung City (TW)

(21) Appl. No.: 13/359,995

(22) Filed: Jan. 27, 2012

(30) Foreign Application Priority Data
Jan. 27, 2011 (TW) 100103155

(51) Int. Cl. F21L 4/00; F21V 7/06; F21V 7/00

(52) U.S. Cl. 362/186; 362/296.01; 362/296.07

(57) ABSTRACT

A light fixture includes a portable light source and a light guide assembly. The light guide assembly includes a reflective mask and a lamp holder. The lamp holder is mounted on the reflective mask for removably positioning the portable light source on the reflective mask. The reflective mask is configured to reflect light emanated from the light source in a predetermined pattern when the portable light source is held in place by the lamp holder.

### BACKGROUND OF INVENTION

1. Field of Invention

The invention relates to a light fixture, and more especially to a light fixture having a light guide assembly removably attached to a portable light source. When the portable light source cooperates with the light guide assembly, the light fixture can provide a desired beam pattern for specialty illumination. Alternatively, the portable light source can be taken separately from the light guide assembly to offer general illumination.

2. Related Prior Art

A conventional light fixture includes a light bulb, a power source and a lamp mask all integrated together and inseparable from one another. This type of light fixture mainly offers specialty illumination for one specific application only.

As disclosed in FIG. 5 of U.S Pat. No. 7,850,348, a bicycle lamp incorporates a lamp cover and a lamp holder integrated together. The bicycle lamp further includes a LED lamp mounted on the lamp holder and a power source on the lamp cover. One part of the light irradiated from the LED lamp is reflected by an reflective surface of the lamp cover to form an illuminating range to project light in a forward direction of the lamp cover, while another part of light irradiated from the LED lamp without being reflected by the reflecting cover can project out of the cover directly, thus that another illuminating range to project light in a downward and/or down-forward directions of the lamp cover is formed.

As described in that patent, the prior art light fixture employs a special cover design for light reflection in order to form a desired light pattern complying with statutes. However, since the bicycle lamp as a whole is mounted on a front rod of a bicycle and the LED lamp inside the cover is inseparable from other parts of the bicycle lamp, the LED lamp can be used only for bicycle lighting. Moreover, the bicycle lamp which is simply mounted on a bike can easily be removed from the bike and be stolen while a bike is alone parked.

### SUMMARY OF INVENTION

The present invention discloses a new and novel light guide assembly and a light fixture using the light guide assembly. In particular, the light fixture incorporates a portable light source which can be detached from the light guide assembly without unreasonable effort, and be used independent of the light guide assembly to offer general illumination.

Specifically, the light fixture includes a light guide assembly and a portable light source removably mounted on the light guide assembly. The light guide assembly includes a reflective mask and a lamp holder. The lamp holder is mounted on the reflective mask for removably positioning the portable light source on the reflective mask. The portable light source includes a housing, a light emitting diode (LED) package, a lens and a battery inside the housing. The LED package is powered by the battery for light emission and the light emanated from the LED package is directed toward outside of the housing via the lens which functions as a secondary optical lens. In addition, the reflective mask is configured to reflect the light emanated from the portable light source into an asymmetrical beam pattern.

As described above, the portable light source can be easily and quick attached to the light guide assembly because of the lamp holder. Upon the portable light source is held in place by the lamp holder, the reflective mask can reflect light emanated from the portable light source into a predetermined light pattern that complies with the statutes. Alternatively, the portable light source can easily be detached from the light guide assembly to offer general illumination. Additional benefits include that it offers enhanced security from being stolen if a user detaches the portable light source from the light guide assembly that is mounted on a vehicle, and takes the portable light source with him since the light fixture, without the portable light source, can do nothing.

Other features, objects, aspects and advantages will be identified and described in detail below.

### BRIEF DESCRIPTION OF DRAWINGS

FIG. 1 is an explosive perspective view of a light fixture in accordance with a first embodiment of the invention;

FIG. 2 is a cross sectional view of the light fixture of FIG. 1;

FIG. 3 is an explosive perspective view of a light fixture in accordance with a second embodiment of the invention; and

FIG. 4 is a cross sectional view of the light fixture of FIG. 3.

### DETAILED DESCRIPTION OF EMBODIMENTS

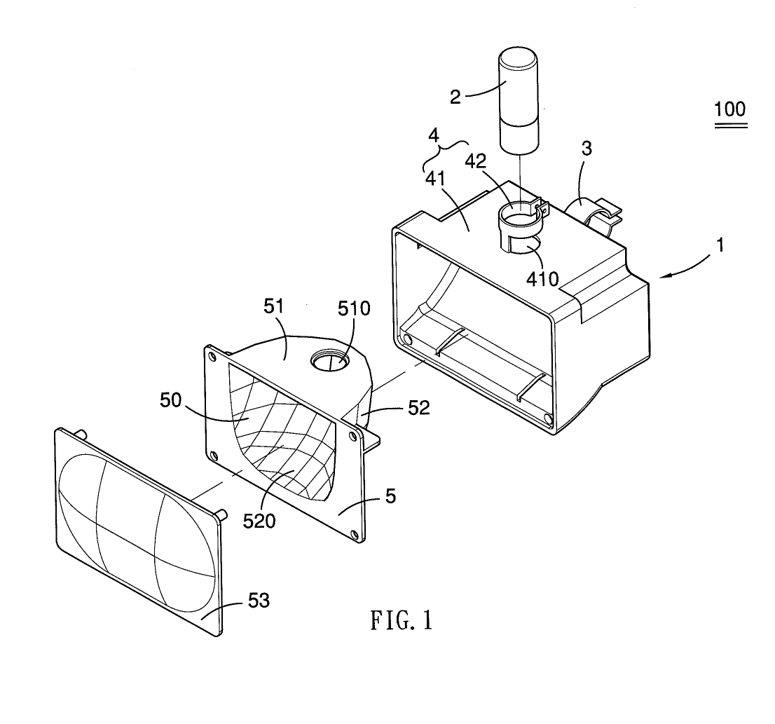

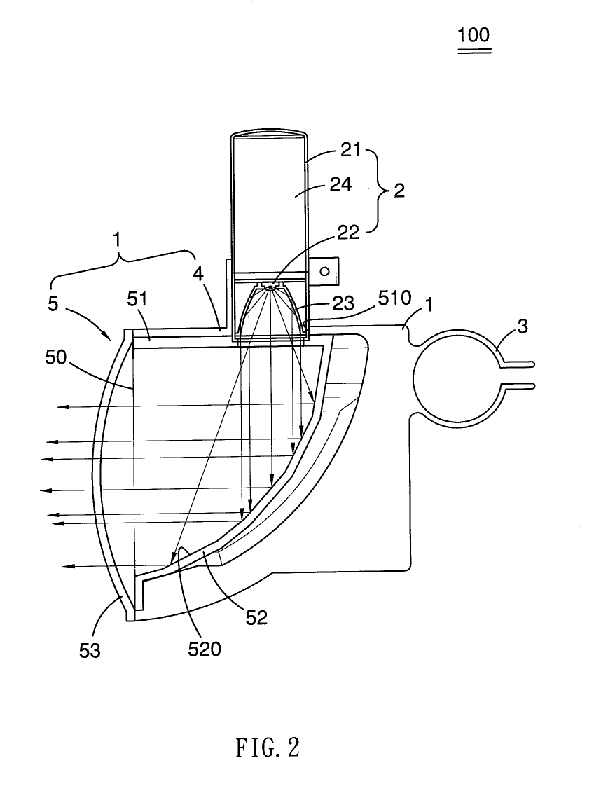

With reference to FIGS. 1 and 2, a light fixture 100 is shown in accordance with a first embodiment of the present invention. The light fixture 100 includes a light guide assembly 1 and a portable light source 2 (such as a flashlight in this embodiment). In particular, the portable light source 2 is removably attached to the light guide assembly 1.

The portable light source 2 is advantageous to offer portable light without the need for external power supply. As shown in FIG. 2, the portable light source 2 includes a housing 21 and is equipped inside the housing 21 with a LED package 22, a total internal reflection (TIR) lens 23, and a battery 24. The LED package 22 is powered by the battery 24 for light emission and the light emanated from the LED package 22 is transformed and directed toward outside of the housing via the TIR lens 23. It is understood that the LED package 22 has a LED die (not shown) and a first optical element encapsulating the LED die. The TIR lens 23, on the other hand, functions as a second optical lens to provide a second optical transformation for light from the LED package 22 and directs the light toward an open end of the housing 21.

The light guide assembly 1 is provided to further transform the light from the TIR lens 22 of the portable light source 2 into a specific beam pattern in compliance with the statutes. Take a bicycle lamp for example; the light guide assembly 1 includes a fastening member 3, a lamp holder 4 and a reflective mask 5. The fastening member 3 is provided for attaching the light guide assembly 1 to a front rod or a handlebar of a bicycle (not shown).

The lamp holder 4 includes a casing 41 in which the reflective mask 5 is received, and a gripping clamp 42 extending from the casing 41. The casing 41 defines an opening 410 in a wall thereof for reception of a front end of the portable light source 2. The gripping clamp 42 of the lamp holder 4 is disposed on a side of the reflective mask 5 and is employed to fasten the portable light source 2 on the casing 41 while the portable light source 2 is inserted in the opening 410 of the casing 41. In this way, the portable light source 2 can be removably positioned on the reflective mask 5

Referring again to FIG. 2, when the portable light source 2 is held in place by the lamp holder 4, the reflective mask 5 transforms light emanated from the portable light source 2 into a predetermined asymmetric beam pattern. Specifically, the reflective mask 5 includes a flat wall 51, an arcuate wall 52 extending from the flat wall 51 and a transparent or translucent cover 53. The flat wall 51 defines a light entry hole 510 therein. Moreover, the flat wall 51 cooperates with the arcuate wall 52 to define a light exit hole 50. The arcuate wall 52 has an inner arcuate reflective surface 520 for light reflection. The cover 53 is, without limitation, coupled to the flat wall 51 and the arcuate wall 52 to cover the light exit hole 50 such that light falls on the reflective surface 520 will be reflected out through the cover 53. In addition, the cover 53 provides protection and keeps the reflective surface 520 of the arcuate wall 52 clean for maintaining light reflection effects for a long time. Preferably, the reflective surface 520 of the arcuate wall 52 is consisting of a plurality of interconnected, flat and sloped sections (see FIG. 1) so as to efficiently guide the light from the portable light source 2 to a desired area in need of illumination.

The lamp holder 4 is disposed in proximity to the light entry hole 510 of the flat wall 51 such that when the portable light source 2 is held in place by the lamp holder 4, as shown in FIG. 2, the reflective mask 5 captures light from the portable light source 2 via the light entry hole 510 and reflects the light in a direction toward the light exit hole 50 via the reflective surface 520 of the arcuate wall 52.

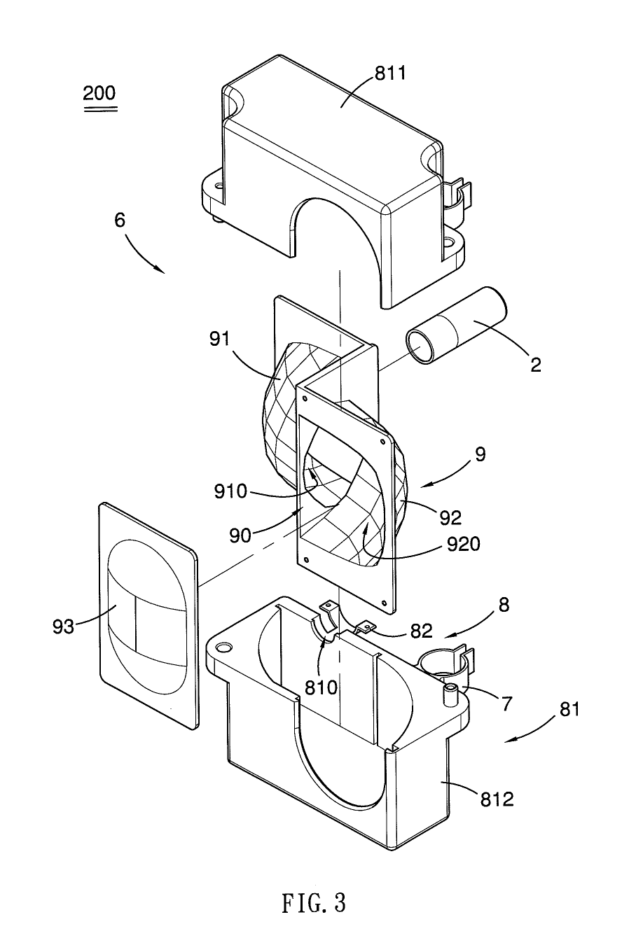

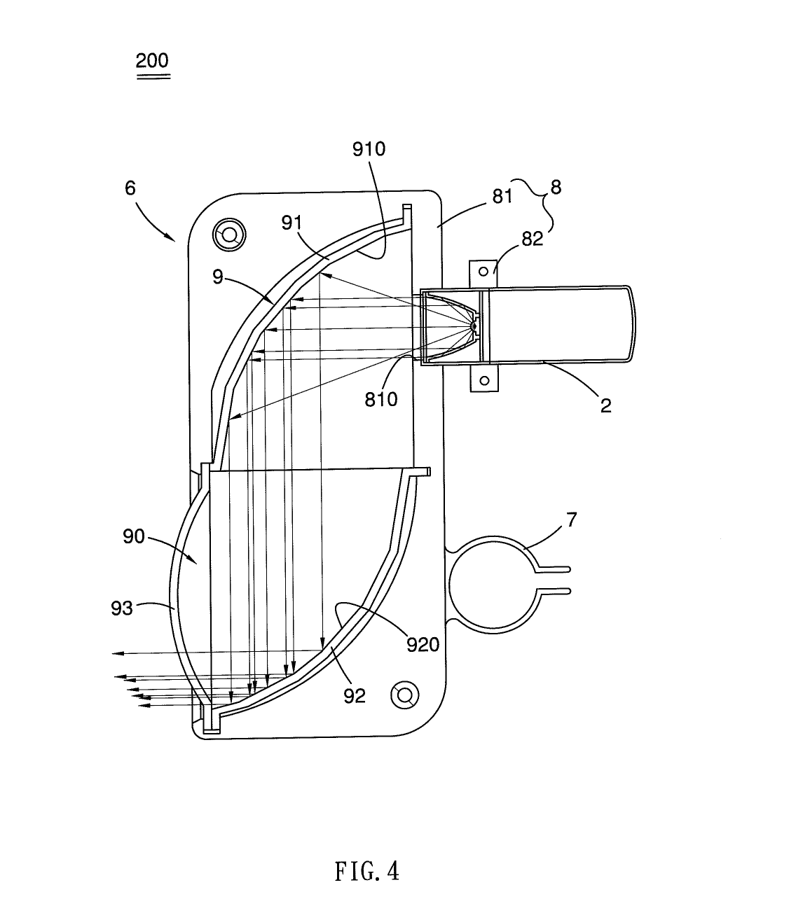

With reference to FIGS. 3 and 4, a light fixture 200 is shown in accordance to a second embodiment of the invention. Similar to the light fixture 100 in FIGS. 1 and 2, the light fixture 200 includes a light guide assembly 6 and a portable light source 2 removably attached to the light guide assembly 6. Differently, the light guide assembly 6 is configured to transform an incident light beam from the portable light source 2 through first and second reflections to an exit light beam substantially parallel to the incident light beam, as depicted in FIG. 4.

The light guide assembly 6 includes a fastening member 7, a lamp holder 8 and a reflective mask 9. The fastening member 7 is provided for attaching the light guide assembly 6 to a front rod or a handlebar of a bicycle (not shown). The lamp holder 8 includes a casing 81 formed by both half-shells 811, 812, and a gripping clamp 82 extending from the lower shell 812 of the casing 81 for removably positioning the portable light source 2 on the reflective mask 5. The reflective mask 9 is housed by the casing 81. The casing 81 defines an opening 810 in a wall thereof for reception of a front end of the portable light source 2. The gripping clamp 82 is employed to fasten the portable light source 2 on the casing 81 while the portable light source 2 is inserted in the opening 810 of the casing 81.

As shown in FIG. 4, when the portable light source 2 is held in place by the lamp holder 8, the reflective mask 9 transforms light emanated from the portable light source 2 into a predetermined asymmetric beam pattern. More precisely, the reflective mask 9 includes a first arcuate wall 91, a second arcuate wall 92 extending from the first arcuate wall 91, a transparent or translucent cover 93. Each of the first and second arcuate walls 91, 92 has an inner arcuate reflective surface 910, 920 for light reflection. Moreover, the reflective mask 9 defines a light exit hole 90 oriented toward the second arcuate reflective surface 920 of the second arcuate wall 92. The cover 93 is, without limitation, provided to cover the light exit hole 90 such that light falls on the reflective surface 920 will be reflected out through the cover 93. The cover 93 provides protection and keeps the reflective surface 920 of the second arcuate wall 92 clean for maintaining light reflection effects for a long time. Preferably, each of the reflective surfaces 910, 920 of the first and second arcuate walls 91, 92 is consisting of a plurality of interconnected, flat and sloped sections (see FIG. 3) so as to efficiently guide the light from the portable light source 2 to a desired area in need of illumination.

The opening 810 of the lamp holder 8 is oriented toward the first arcuate reflective surface 910 of the first arcuate wall 91 of the reflective mask 9 such that when the portable light source 2 is held in place by the lamp holder 8, as shown in FIG. 4, the reflective mask 9 captures light from the portable light source 2 via the opening 810 and reflects the light firstly with the first arcuate reflective surface 910 of the first arcuate wall 91 and then reflects secondly with the second arcuate reflective surface 920 of the second arcuate wall 92 toward the light exit hole 90.

It will be appreciated that although a particular embodiment of the invention has been shown and described, modifications may be made. It is intended in the claims to cover such modifications which come within the spirit and scope of the invention.

The invention claimed is:

1. A light guide assembly comprising:
a reflective mask; and
a lamp holder mounted on the reflective mask for removably positioning a portable light source on the reflective mask;
wherein the reflective mask is configured to reflect light emanated from the light source into a predetermined pattern when the portable light source is held in place by the lamp holder.

2. The light guide assembly of claim 1, wherein the reflective mask is configured to transform light emanated from the light source into an asymmetric beam pattern.

3. The light guide assembly of claim 2, wherein the reflective mask includes an arcuate reflective surface for reflecting light from the portable light source.

4. The light guide assembly of claim 2, wherein the reflective mask includes a flat wall defining a light entry hole therein and an arcuate wall extending from the flat wall and having an inner reflective surface; the flat wall cooperates with the arcuate wall to define a light exit hole; and the lamp holder is disposed in proximity to the light entry hole of the flat wall such that when the portable light source is held in place by the lamp holder, the reflective mask captures light from the portable light source via the light entry hole and reflects the light in a direction toward the light exit hole via the inner reflective surface of the arcuate wall.

5. The light guide assembly of claim 2, wherein the reflective mask has a first arcuate reflective surface and a second arcuate reflective surface and a light exit hole oriented toward the second arcuate reflective surface of the reflective mask; the lamp holder has an opening oriented toward the first arcuate reflective surface of the reflective mask such that when the portable light source is held in place by the lamp holder, the reflective mask captures light from the portable light source via the opening and reflects the light first with the first arcuate reflective surface and then with the second arcuate reflective surface toward the light exit hole.

6. The light guide assembly of claim 1, wherein the lamp holder includes a gripping clamp to retain the portable light source in position.

7. A light fixture comprising a portable light source and a light guide assembly, wherein the light guide assembly includes:
a reflective mask; and
a lamp holder mounted on the reflective mask for removably positioning the portable light source on the reflective mask;
wherein the reflective mask is configured to reflect light emanated from the light source into a predetermined pattern when the portable light source is held in place by the lamp holder.

8. The light fixture of claim 7, wherein the portable light source includes a housing, a light emitting diode (LED) package disposed in the housing, a lens and a battery; and the LED package is powered by the battery for light emission and the light emanated from the LED package is directed toward outside of the housing via the lens.

9. The light fixture of claim 8, wherein the reflective mask is configured to transform light emanated from the light source into an asymmetric beam pattern.

10. The light fixture of claim 9, wherein the reflective mask includes an arcuate reflective surface for reflecting light from the portable light source.

11. The light fixture of claim 9, wherein the reflective mask includes a flat wall defining a light entry hole therein and an arcuate wall extending from the flat wall and having an inner reflective surface; the flat wall cooperates with the arcuate wall to define a light exit hole; and the lamp holder is disposed in proximity to the light entry hole of the flat wall such that when the portable light source is held in place by the lamp holder, the reflective mask captures light from the portable light source via the light entry hole and reflects the light in a direction toward the light exit hole via the inner reflective surface of the arcuate wall.

12. The light fixture of claim 9, wherein the reflective mask has a first arcuate reflective surface and a second arcuate reflective surface and a light exit hole oriented toward the second arcuate reflective surface of the reflective mask; the lamp holder has an opening oriented toward the first arcuate reflective surface of the reflective mask such that when the portable light source is held in place by the lamp holder, the reflective mask captures light from the portable light source via the opening and reflects the light first with the first arcuate reflective surface and then with the second arcuate reflective surface toward the light exit hole.

13. The light fixture of claim 8, wherein the lamp holder includes a gripping clamp to retain the portable light source in position.
